(19) United States
(12) Patent Application Publication
(10) Pub. No.: US 2008/0219187 A1
(43) Pub. Date: Sep. 11, 2008

(54) METHOD FOR DATA PROCESSING IN BRIDGED NETWORK, BRIDGE AND BRIDGED NETWORK

(75) Inventor: Shimin ZOU, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/118,544

(22) Filed: May 9, 2008

Related U.S. Application Data
(63) Continuation of application No. PCT/CN2006/003000, filed on Nov. 9, 2006.

(30) Foreign Application Priority Data
Nov. 11, 2005 (CN) 200510124409.5

(51) Int. Cl. H04L 12/28

(52) U.S. Cl. 370/256

(57) ABSTRACT

A method for data processing in a bridged network includes: spanning tree is generated in the bridged network, and a unicast forwarding table of the spanning tree is established by using a register packet by the bridge; when a data packet out of the bridge network arriving the bridge network, from an entrance bridge arrived by the data packet, the data packet is transferred basing on the unicast forwarding table along the spanning tree and the data packed is transmitted through an outer port of an exit bridge in the exit bridge. According to the method and system for data processing in the bridged network, the unicast forwarding table is established by the control protocol, original processing of address learning can be closed. Therefore, software may be upgraded easily and the burden of hardware processing is reduced.

### CROSS-REFERENCE TO RELATED APPLICATIONS

The present application is a continuation of PCT application No. PCT/CN2006/0030000 filed on Nov. 9, 2006, which claims priority from the Chinese patent application No. 200510124409.5 submitted with the State Intellectual Property Office of P.R.C. on Nov. 11, 2005, entitled “Method for Data Processing in Bridged Network, Bridge and Bridged Network,” both of which are hereby incorporated by reference in their entirety.

### FIELD OF THE INVENTION

The present invention relates to the field of communication, and more particularly to a method for data processing in bridged network, a bridge and a bridged network.

### BACKGROUND OF THE INVENTION

In a traditional Ethernet bridged network using spanning trees to transfer data, because the same spanning trees are used to transfer data in a broadcast domain (including data transfer in multi-broadcast domains using the same spanning trees), a data transfer table is established by address learning upon user data packet passes through bridged network (referred to IEEE 802.1D). When the spanning tree topology is changed, the address is learned again.

Further, in addition to being transferred in accordance with the MAC address information, the data packet may also be transferred in accordance with the VLAN configure information by dividing different broadcast domains, which are divided by the VLAN. (referred to IEEE 802.1Q)

It can be seen that, in the existing Ethernet which uses the spanning tree to transfer data, the establishment of data transfer table with VLAN is driven by the user data stream according to the user data packet MAC address learning.

Because in the traditional data packet transfer patterns the data transfer table inside the bridged network depends on the user address establishment or is established by the driven of user data stream, the large number of MAC users served by the bridged network will impact on the performance of the bridged network, and the large number of user data packets will be broadcasted in the bridged network because the address is learned again when the topology is changed, before the data transfer table is established.

The first technical solution of the prior art:

Nortel proposes a solution with the patent No. US 2004/0184408 for the network of service providers having capability of avoiding storing and processing over many MAC addresses to enhance capability of the network of service providers. The solution adopts a mechanism of MAC in MAC. The basic art is that when the user data packet reaches the network bridge of the service providers, that is, the boundary line of the service providers, the service providers re-encapsulate an outer MAC header, which includes a source service provider address and a destination service provider address.

For the encapsulation of the outer MAC header, a service provider boundary device needs to use a received resource address, which has an outer MAC header data packet, to process mapping learning of a user destination MAC address, a destination service provider address and a service provider destination address. The service provider address is a network inner address of the service provider. Using the art, the network core bridge of the service provider can shield the MAC address of the users. In a bridged network a data transfer table is established on the basis of an address learning of the service provider.

But the art depends on the driving of the user data stream to establish the data transfer table. The bridged network does not need to store a user inter address but still needs to learn according to the user data stream (including an encapsulated user data stream). So operating time occupied by the learning is not reduced obviously.

Further, when a spanning tree topology is changed, lots of user data is broadcasted in the bridged network before the data transfer table is established because address learning is needed again based on the user data.

The second technical solution of the prior art:

A patent with the patent No. 003642481 and titled Network System, Learning Bridge Node, Learning Method and Program solves a basic problem to implement the establishing a data transfer table about MAC by TAG learning and adapting data packet by TAG in a spanning tree topology with an asymmetric route. The method is as that the bridge node sends the learning packet along the opposite direction of the route of a user data stream periodically. The learning packet includes TAG and the corresponding source address which derives from a buffering table of the MAC source address. With this solution, the transfer marker TAG may be learned in most conditions of asymmetric route.

However, the art does not describe how to choose a reverse route to transfer learning packets and that is a key point of solving the art problem. An aim of the asymmetric learning is to make a user data stream obtain a transfer route. The route of a user data stream is not known so learning packets can not be broadcasted along a route opposite the direction of the user data stream.

The patent does not show a clear technical solution about how to treat the former process of address learning of user data packet.

The art adopts TAG transfer, so it is not compatible with the prior art which transfers data using a MAC address.

The TAG learning of the art correlates with a source MAC address of a cache memory, and therefore large number of user MAC addresses brings difficulty to TAG distributing and brings large load to network of operator when the act is adopted in a service provider network.

### SUMMARY OF THE INVENTION

An embodiment of the present invention provides a method for data processing in a bridged network and a bridged network to solve the problem in the prior art, that is, the overload brought to bridged network by handling of the user MSC address and the effect on the transfer of user data packet when the topology of the spanning tree is changed.

A method for data processing in bridged network connected by a bridge includes: generating a spanning tree in the bridged network, and establishing a unicast forwarding table of the spanning tree by the bridge using a register packet; when a data packet out of the bridge network arrives at the bridge network, according to the unicast forwarding table, transferring the data packet from an entrance bridge where the data packet arrives along the spanning tree, then transmitting the data packet through an outer port of an exit bridge in the exit bridge.

A bridge includes: a control protocol body unit adapted to establish a unicast forwarding table which is a unicast forwarding table of a spanning tree in the bridged network; a forwarding table storage unit adapted to store the unicast forwarding table; a data packet transfer unit adapted to transfer a received data packet according to the unicast forwarding table.

A bridged network connected by the bridge includes: a control protocol body unit adapted to establish a unicast forwarding table which is a unicast forwarding table of a spanning tree in the bridged network; a forwarding table storage unit adapted to store the unicast forwarding table; a data packet transfer unit adapted to transfer a received data packet according to the unicast forwarding table.

A transfer table is established for the bridge or the bridge port address and a unicast forwarding table is established for the generation or change of topology of the bridged network in the bridged network. So that the number of the MSC addresses of establishing processing of the unicast forwarding table is reduced greatly and the time occupied by establishing the unicast forwarding table is also reduced greatly.

The unicast forwarding table is established for address learning of topology elements in the bridged network. After the inner topology is changed, a control protocol body unit establishes a unicast forwarding table about the address of the network topology elements quickly, so that lots of user data packets will not be broadcasted after the topology is changed.

In a method and system for data pressing in the bridged network, the unicast forwarding table may be established by the control protocol (spanning tree protocol), the original processing of the address learning of data plane can be closed. Therefore, software may be upgraded easily and the burden of hardware processing is reduced.

### BRIEF DESCRIPTION OF THE DRAWINGS

FIG. 1 is a block diagram of a bridged network of the embodiment of the present invention;

FIG. 2 is a flow diagram of the establish of a unicast forwarding table of the embodiment of the present invention;

FIG. 3 is a block diagram of a bridge of the embodiment of the present invention; and

FIG. 4 is a block diagram of a control protocol body unit of the embodiment of the present invention;

### DETAILED DESCRIPTION OF THE EMBODIMENTS

The embodiments of the present invention are further described in connection with the drawings.

A technical solution of the present invention is applied in a bridged network which is connected by bridges. In the bridges networks control protocol can be adopted, such as extending existing Spanning Tree Protocol (STP)/Multi-Spanning Tree Protocol (MSTP) or Generic Attribute Registration Protocol (GARP) and registering of a network topology element address processing by bridged network such as a bridge address in the bridged network and a bridge port address.

A technical solution of an embodiment of the present is processing the tree protocol to form a spanning tree in the bridged network and establishing a unicast forwarding table of the bridged network by transmitting a register packet. Here control protocol can be adopted in the establishing process of the unicast forwarding table, which may not be driven by user data stream. The protocol as mentioned above is capable of controlling the bridged network while keeping independence of the user data stream. A control protocol body unit is set in a bridge to control the establishment of the unicast forwarding table and replace the corresponding register of the bridge.

A technique of MAC in MAC can be adopted in encapsulating data packet in an embodiment of the present invention. In an entrance bridge that is entered by the data packet from an outer port of the bridged network, before the data packet is transmitted on an inner port, an outer MAC header, which is the furthest MAC header in a data packet encapsulated muti-MAC header, is added in the data packet. A source address included in the MAC header includes an address of the entrance bridge or an outer port address of the entrance bridge. A destination address included in the MAC header is an address of an exit bridge or an outer address of the exit bridge from which the data packet is transmitted. The processed data packet is transferred in the bridged network along the unicast forwarding table set by the embodiment of the present invention. The encapsulated outer header is needed take out in an exit of the bridged network. It is permitted that format and occupying digit of the address of the outer MAC header is different of that of the inner MAC header. The inner MAC header is the second MAC header in the data packet encapsulated muti-MAC headers.

When the technical solution of the embodiment of the present invention is used, source address learning process of the previous data packet is closed for other bridge ports except outer ports of the bridged network which is a bridge port of the bridged network connecting with devices out of the bridged network and can also be called the user port.

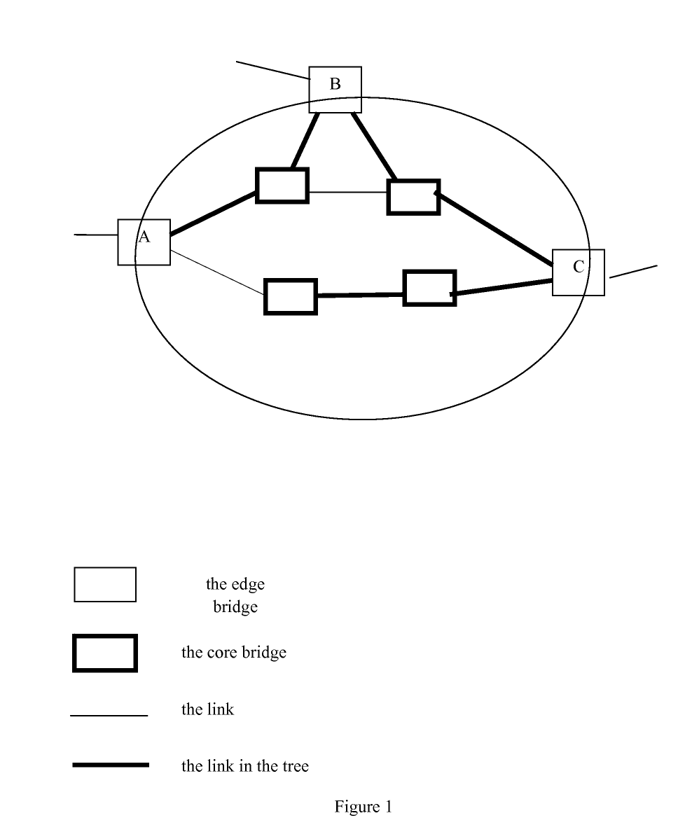

As shown in FIG. 1, a structure diagram of the bridged network of the embodiment of the present invention is illustrated. It can be seen from the figure that a panning tree based on root B is built in the network. The edge bridge has an MAC in MAC encapsulation mechanism, and is able to initialize the control protocol to build a unicast forwarding table. The core bridge, which links the other two bridges in a bridged network and is referred as a core bridge, and the edge bridge, which includes outer ports of the bridged network, may build a unicast forwarding table with register message.

A detailed description of the procedure for establishing a unicast forwarding table is provided in accordance with the embodiment of the present invention.

First, except for the outer ports, the control unit of the protocol of each bridge node sends register packets periodically to root ports or the specified ports of the bridged network on their volunteer. A register packet, which can also be called the register message, includes a source address, a destination address and a register address.

The register address is the address of one or more elements of the network topology of the bridge which sends register packets, such as the MAC address of the outer ports of the bridged network or the MAC address of the bridge in such procedure. The MAC destination address contained in the register packet may be a specified multicast address such as a predetermined multicast address of the control protocol unit or the register packet of the multicast address is a destination address which is only handled by the control protocol unit.

The middle bridge receives the register packet, and obtains one or more items of the transfer table including a destination MAC address, the corresponding source address, and a transmit port, with the addresses of the network topology elements and the relating receiving ports. The bridge adds the items of the transfer table in to the transfer database. The bridge then transfers the data to the root port which is not the receiving ports of the spanning tree or the specified ports which are not the outer ports, until the register packet is transferred to all bridges of the spanning tree and the unicast forwarding table is established.

In this solution, the protocol control unit which receives and handles the register packet has a corresponding aging mechanism for the network topology elements of the register packet, the same as the aging mechanism of the traditional bridges.

Further, the original unicast forwarding table is deleted and a new spanning tree is generated again when the network topology is changed and the above procedures are repeated to control the register process.

The solution is further optimized in the case that a bridge may send a register packet in a period at the requirement of the management configuration.

The solution is further optimized in the case that if a bridge is a core node without outer ports, it is not necessary to send register messages on its volunteer.

The solution is further optimized in the case that each bridge besides the root bridge can be locally build items of a transfer including a MAC address of a root bridge and the number of the root port table, while the protocol control unit to build a transferring process of the data forwarding table is not necessary.

The aforesaid outer ports may be predetermined in the implementations above.

The solution is further optimized in the case that the outer ports may not be configured, and the sending of the register packets is no more focused on the outer ports. However, because the register packet is a newly defined protocol packet, the packets sending to the outer ports will be discarded outside the bridged network.

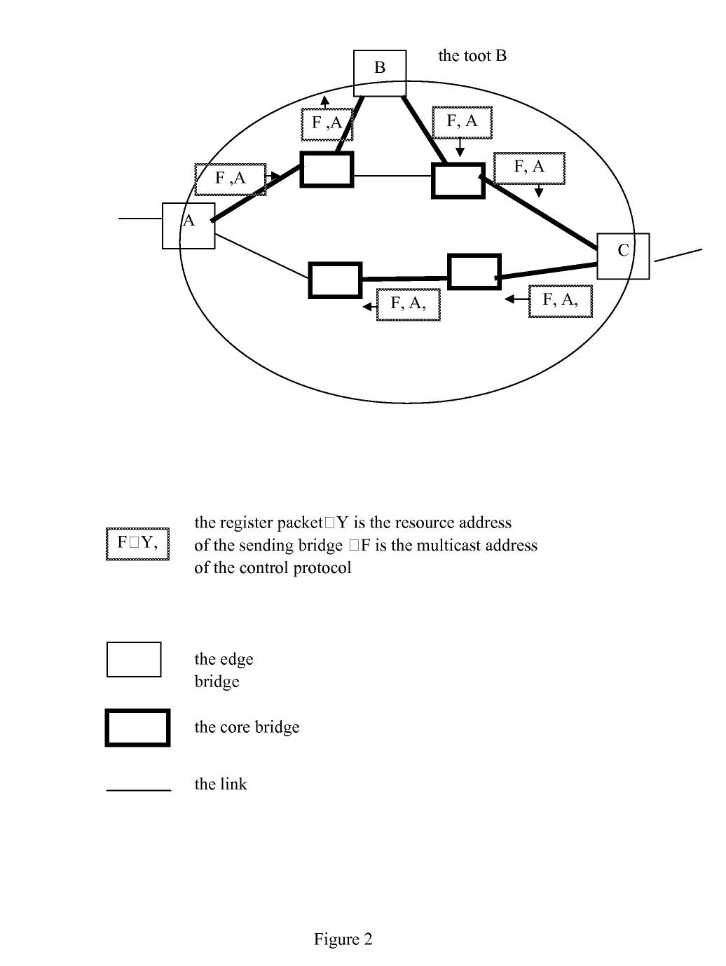

As shown in FIG. 2, the establishment of the unicast forwarding table issued by the protocol control unit according to the embodiment of the present invention is illustrated. When the edge bridge A knows C is generated by the root of the spanning tree, it initializes to build the unicast forwarding table on it volunteer, and send the register packet which is all along transferred to the root of the spanning tree. The protocol control unit receiving the register packet builds items of a transfer table based on the address of the edge bridge A and the receiving ports. The destination address may be the multicast address of the protocol control unit in order to offer facilities for the protocol control unit to receive the register packet.

The unicast forwarding table of the embodiment of the present invention may be built through other solutions. For example, the protocol control unit of each edge bridge issues a register process of the register address, which is responsible for establishing a unicast forwarding table, controlled by the protocol control unit. The register address is derived from the user source address obtained through the address learning at arrival of the edge bridge by the external user data packets of the bridged network, and the addresses of the network topology elements. The user source address is complied at the aging process of the traditional address learning. Further such register addresses are also called access addresses of the edge bridges and the establishment of the unicast forwarding table is more detailed as follow:

The protocol control unit of the edge bridge sends the register packer having its register address, the destination address of which is a specified multicast address used by the protocol control unit.

Additionally, the register packet also contains one or more register addresses and register types including adding and deleting. The resister packet is broadcasted along the spanning tree, that is, the register packet is sent to all the outer ports of the network which is not in the bridged network and named none user access ports. The process may be optimized if the register packet is not sent to the user ports.

After the protocol control unit receives the register packer, one or more items of the transfer table including a register address and the port is obtained from the register address of the receiving ports and the register packets, upon the type of the register is add, while the original corresponding items of the transfer table including a register address and the port is deleted from the register address of the receiving ports and the register packets, upon the type of the register is delete.

The register packet continuously broadcast along the spanning tree in accordance with the edge bridge specified by the register packet. In other words, the register packet is transmitted to all ports which are not receiving ports till the register packet is transferred to the all bridges of the spanning tree. Such process may be optimized for the register packet not sending to the user ports.

The solution is further optimized in the case that when the topology of the spanning tree is changed, the edge bridge transmits the user register packet based on its register address and the processing of the register packet is the same as the above description.

The solution is further optimized in the case that a verification mechanism is adopted between the register packet sending bridge and the register packet receiving bridge. The verification packet is sent to the register packet sending bridge upon the bridge node receives the register packet. If the valid verification packet is not received in a certain period by the sending bridge, the register packet is transmitted again; otherwise the register packet is stopped to be sent.

The data transferring of the above solution may be optimized as follows. When the topology is changed, the edge bridge will handle the register packet after waiting for a certain time, and transmit the unicast user data packet again to avoid the affection of large broadcast of the data packets.

The above solution may be optimized in the case that the register packet is further allowed to contain VLAN information, and the transferring of the register packet is restricted by the VLAN, like the traditional data packet containing VLAN is restricted by the VLAN configuration.

The above register process may be alternatively as follows:

The protocol control unit of the edge bridge transmits its register packet containing the register address in period. The destination address of the message is a specified multicast address used by the protocol control unit. In addition, the message further includes one or more register addresses. The message is broadcasted along the spanning tree, that is, the register packet is transmitted to all ports of the spanning trees, which are not the outer ports. Moreover, the process may be optimized as the register packet not sending to the user ports.

After the register packet of the register address are received by the protocol control unit of each bridge, one or more items of the transfer table including a register address and a port is obtained from the register address of the receiving ports and the register packets, and the register packet continues on broadcasting along the spanning tree rooted by the edge bridge according to the edge bridge specified by the register packet, that is, the register packet is transmitted to all the ports which are not the outer ports and the process may be preferred as the register packet not sending to the user ports.

Further, the above solution may be further optimized in the case that when the topology of the spanning tree is changed, the register packet is sent by the edge bridge immediately according to its register address. And the processing of the register packet is the same as the step 1 and step 2.

The bridge nodes employ the traditional aging mechanism to perform the aging mechanism to the items of the transfer table it establishes.

The data transferring of the above solution may be optimized when the topology is changed, the edge bridge will handle the register packet after waiting for certain period of time, and transmit the unicast user data packet again to avoid the affection of large broadcast of the data packets.

A new bridge and a bridged network of the same are provided by the embodiments of the present invention. The bridged network is connected through the bridge nodes. After the data packet from the outer ports is at arrival of the bridged network, the data packet is transferred basing on the unicast forwarding table in the bridged network.

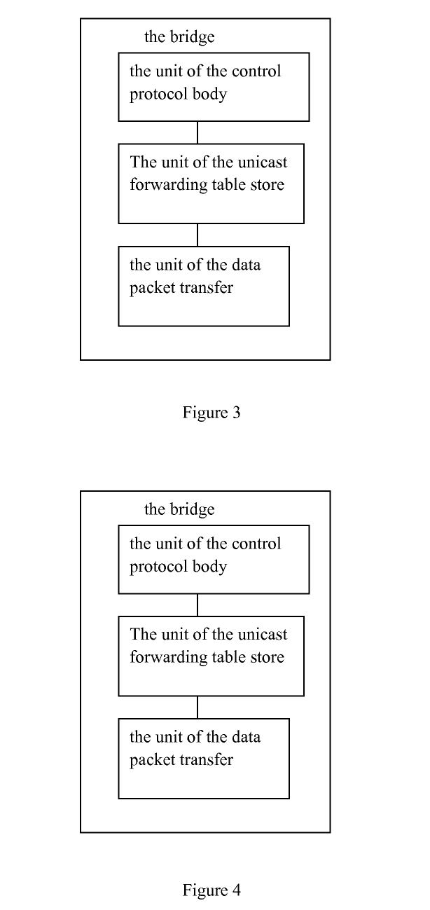

As shown in FIG. 3, a structure diagram of the bridge in the bridged network according to the embodiment of the present invention is illustrated. It can be seen that the bridge of the bridged network includes: a control protocol body unit adapted to establish a unicast forwarding table which is a unicast forwarding table of a spanning tree in the bridged network; a forwarding table storage unit adapted to store the unicast forwarding table; and a data packet transfer unit adapted to transfer a received data packet according to the unicast forwarding table.

AS shown in FIG. 4, a structure diagram of the control protocol body of embodiment of the present invention is illustrated. It can be seen that the control protocol body unit may include: a register packet processing unit adapted to receive a register packet transmitted by other bridges and establish a unicast forwarding table; a register packet transmitting unit adapted to transmit the register packet to a root port of the spanning tree; a verification packet transmitting unit adapted to transmit, after the register packet processing unit receives the register packet, a verification packet to a bridge transmitting register packet; and a verification packet receiving and determining unit adapted to set a time threshold of receiving the verification packet, the bridge transmitting register packet transmitting the register packet again when the bridge transmitting register packet does not receive a verification packet in the setting time threshold.

The embodiments of the method and system for data processing in the bridged network provide the unicast forwarding table which is established by the control protocol that is called the spanning tree protocol. Original processing of address learning can be closed. Software can be upgraded easily and the load of hardware processing is reduced.

The number of the MAC address can be largely reduced and the time for establishing the transfer table is shorten during the establishment of the transfer table for the control protocol is built only to a transfer table for bridge or bridge port address and the transfer table is established only when the topology of the bridged network is generated or changed in the bridged network.

Because the establishment of the transfer table is based on the address learning of the network topology elements in the bridged network, the protocol control unit of the bridge in the bridged network will immediately build a data transfer table of the network topology elements addressees after the side topology is changed. Therefore, it will not lead the large number of user data packets to be broadcasted after the change of the topology.

It should be understood that the above embodiments are used only to explain, but not to limit the present invention. In despite of the detailed description of the present invention with referring to above preferred embodiments, it should be understood that various modifications, changes or equivalent replacements can be made by those skilled in the art without departing from the spirit and scope of the present invention and covered in the claims of the present invention.

What is claimed is:

1. A method for data processing in a bridged network which is connected by bridges, comprising:
forming a spanning tree in a bridged network, and establishing a unicast forwarding table of the spanning tree by a bridge using a register packet;
when a data packet out of the bridge network arrives at the bridge network, according to the unicast forwarding table, forwarding the data packet from an entrance bridge where the data packet arrives along the spanning tree, then transmitting the data packet through an outer port in the exit bridge.

2. The method according to claim 1, encapsulating the data packet with an outer address in the entrance bridge and de-encapsulating the encapsulated outer address in the exit bridge.

3. The method according to claim 1, wherein the establishing the unicast forwarding table comprises:
A, after the spanning tree is spanned, transmitting a register packet by the bridge on the spanning tree along the spanning tree and the register packet carrying information of a source address, destination address and register address;
B, obtaining and recording forwarding table entries according to the information of the register packet and a receiving port, after a middle bridge receives the register packet, the middle bridge transferring the register packet until the register packet is transferred to all of the bridge of the spanning tree.

4. The method according to claim 3, wherein the transmitting register packet along the spanning tree in the step A comprises:
transmitting the register packet to ports of the spanning tree, which are not outer ports, by the bridge of the spanning tree; or
broadcasting the register packet along the spanning tree by an edge bridge of the spanning tree.

5. The method according to claim 3, wherein the information of the register address in the step A is one or more register addresses.

6. The method according to claim 5, wherein the register address is an outer port address of the bridged network, an address of the bridge or a user MAC address.

7. The method according to claim 3, wherein the destination address is a multicasting address and the source address is an address of a bridge initializing a register.

8. The method according to claim 3, wherein the items of the transfer table in the step B comprise a destination MAC address and a transmit port identification.

9. The method according to claim 3, further comprising:
transmitting, by a bridge receiving register packet, a verification packet to a bridge transmitting register packet after receiving the register packet; and
transmitting register packet transmitting the register packet again if the bridge transmitting register packet does not receive the verification packet within a preset time threshold.

10. The method to claim 3, further comprising:
transmitting, by the bridge of transmitting the register packet, a canceling register packet, and after a registered bridge receives the canceling register packet, canceling the register and deleting the corresponding forwarding table entries.

11. The method according to claim 3, comprising: when a topology of the bridged network is changed, canceling an original unicast forwarding table, and establishing a new unicast forwarding table when a new spanning tree is formed.

12. The method according to claim 3, wherein the step A is processed periodically.

13. The method according to claim 1, wherein a source address learning process of the data packet is closed for the bridge ports except the outer ports of the bridged network.

14. Abridge, comprising:
a control protocol body unit adapted to establish a unicast forwarding table which is a unicast forwarding table of a spanning tree in the bridged network;
a forwarding table storage unit adapted to store the unicast forwarding table; and
a data packet transfer unit adapted to transfer a received data packet according to the unicast forwarding table.

15. The bridge according to claim 14, wherein the control protocol body unit comprises:
a register packet processing unit adapted to receive a register packet transmitted by other bridges and establish a unicast forwarding table; and
a register packet transmitting unit adapted to transmit the register packet to a root port of the spanning tree.

16. The bridge according to claim 15, wherein the control protocol body unit further comprises:
a verification packet transmitting unit adapted to transmit, after the register packet processing unit receives the register packet, a verification packet to a bridge transmitting register packet; and
a verification packet receiving and determining unit adapted to set a time threshold of receiving the verification packet, and the bridge transmitting register packet transmits the register packet again when the bridge transmitting register packet does not receive a verification packet in the setting time threshold.

17. Abridged network connected by a bridge, wherein the bridge comprises:
a control protocol body unit adapted to establish a unicast forwarding table which is a unicast forwarding table of a spanning tree in the bridged network;
a forwarding table storage unit adapted to store the unicast forwarding table; and
a data packet transfer unit adapted to transfer a received data packet according to the unicast forwarding table.

18. The bridged network according to claim 17, wherein the control protocol body unit comprises:
a register packet processing unit adapted to receive a register packet transmitted by other bridges and establish a unicast forwarding table; and
a register packet transmitting unit adapted to transmit the register packet to a root port of the spanning tree.

19. The bridged network according to claim 18, wherein the control protocol body unit further comprises:
a verification packet transmitting unit adapted to transmit, after the register packet processing unit receives the register packet, a verification packet to a bridge transmitting register packet; and
a verification packet receiving and determining unit adapted to set a time threshold of receiving the verification packet, and the bridge transmitting register packet transmits the register packet again when the bridge transmitting register packet does not receive a verification packet in the setting time threshold.
